(19) United States
(12) Patent Application Publication
(10) Pub. No.: US 2009/0197083 A1
(43) Pub. Date: Aug. 6, 2009

(54) HEAT-RESISTANT RESIN COMPOSITION AND INSULATED WIRE INSULATED THEREWITH

(76) Inventors: Takashi INOUE, Yonezawa (JP); Kenichiro Fujimoto, Hitachi (JP); Kentaro Segawa, Hitachi (JP); Tomiya Abe, Hitachi (JP); Hitoshi Kimura, Hitachi (JP)

Correspondence Address: MATTINGLY & MALUR, P.C., 1800 DIAGONAL ROAD, SUITE 370, ALEXANDRIA, VA, 22314, US

(21) Appl. No.: 12/362,051

(22) Filed: Jan. 29, 2009

(30) Foreign Application Priority Data
Feb. 1, 2008 (JP) 2008-022671

(51) Int. Cl. B32B 15/02; C08L 67/06; C08L 53/00; B82B 1/00

(52) U.S. Cl. 428/372; 525/451; 525/190; 525/92 R; 977/773

(57) ABSTRACT

A heat-resistant resin composition comprised of a mixture prepared by kneading a polybutylene terephthalate resin together with a component different from said polybutylene terephthalate resin, wherein a β relaxation peak of said heat-resistant resin composition on the tan δ curve determined by the dynamic viscoelasticity measurement defined in Japanese Industrial Standard K 7244-4 appears at a temperature lower than a temperature at which a β relaxation peak of a composition composed singly of a polybutylene terephthalate appears; and said another component is dispersed in said polybutylene terephthalate resin phase in a form of particles having sizes of 1 μm or smaller.

### TECHNICAL FIELD

The present invention relates to a heat-resistant resin composition and an insulated wire insulated therewith. More particularly, the invention relates to a heat-resistant resin composition having excellent tensile elongation properties. This resin composition is a kneaded mixture of polybutylene terephthalate (PBT) and a component different form PBT. The invented resin composition has a βrelaxation peak temperature that is shifted to a temperature lower than the βrelaxation peak temperature of PBT by applying kneading to such mixture, wherein the β relaxation peak temperature is a temperature at which the β relaxation peak on the tan δ curve determined by a dynamic viscoelasticity measurement applied to a substance in question will appear. The invention further relates to an insulated wire insulated with the heat-resistant resin composition defined as above.

### BACKGROUND ART

Conventionally, the polyvinyl chloride (PVC) has been commonly used as an electrical insulant. PVC-based insulation materials are excellent insulant in that they are highly practicable and economical. Such insulation materials however generate chlorine-containing gasses when they are destructed by fire causing a problem of environmental pollution. Recently, this problem has increasingly desired those materials other than PVC.

In the transportation field such as automobiles or railway cars, the viewpoint of energy saving demands the lightening of car bodies and the reducing of wiring spaces. As a consequence of this demand, wires for such field are required to be lightweight and to be thin in insulation thickness.

With these requirements for lighter weight and thinner thickness, wires have had problem in that the flame retardancy and abrasion resistivity would not satisfy the given specification if conventional PVC is used as the insulation material thereon.

On the other hand, polybutylene terephthalate (PBT) is used in various fields such as automobile, electrical and electronics, insulant and office automation appliances in appreciation of its excellent properties among similar materials. PBT is a polyester resin that is one of general-purpose engineering plastic polymers. PBT, which is a crystalline polymer, has excellent properties in: heat-resistivity, physical strength, electrical characteristics, chemical-resistivity, and formability; moreover, it exhibits a low water absorption rate and a high dimensional stability. (These performances are described for example in JP2968584B, JP3590075B, JP2002-343141A and JP3650474B.)

Since the general-purpose engineering plastics of these kinds provide such useful features as mentioned above, using such plastics as an insulation material will make it feasible to obtain wires with lighter weight and thinner insulation thickness yet maintaining flame retardancy and abrasion resistivity. Conventionally, the thickness of wires for railway cars was some 0.5 mm. Energy saving or ecological consideration however come to require wires for such purpose to be more thinner in insulation thickness, 0.3 mm or thinner for example.

A use of polyester resin in a response to this downsizing requirement however encounters such a problem that the crystallinity thereof changes under certain conditions or during manufacturing. This is because of polyester resin being a crystalline polymer. Particularly, when the resin undergoes a thermal treatment, the crystallinity grows to a large degree lowering the tensile elongation of the insulation material, which is an essential property of a wire insulation material.

JP2006-111655A and JP2006-111875A mention such a technique as applies a thermal treatment or adds a crystallization accelerator to such material to improve its crystallinity for enhanced physical strength, high-speed formability, and productivity.

### SUMMARY OF INVENTION

However, it is concerned that accelerating crystallization results in the tensile elongation deterioration.

JP2005-213441A mentions that introduction of a flexible monomer as a raw material for polyester resin controls undesired growth of crystallization. The literature however does not mention any aspect in terms of behavior of tensile elongation.

JP2004-193117A describes such a finding that adding a resin, which contains a functional group that is reactive with a polyester-based resin, to polyester resin suppresses occurrence of crazing, which leads to high-performance in insulation properties at high temperatures preventing lowering of breakdown voltage. The literature however does not mention any effects of heat on the tensile elongation of electrical insulation materials.

Based on these situations above, the present invention provides a heat-resistant resin composition as does not cause lowered physical strength, particularly tensile elongation, in polyester resin particularly PBT resin, even after exposure to heat. The invention further provides an insulated wire insulated with the invented heat-resistant resin composition.

According to a first aspect of the present invention, A heat-resistant resin composition is comprised of a mixture prepared by kneading a polybutylene terephthalate resin together with a component different from said polybutylene terephthalate resin, wherein a p relaxation peak of said heat-resistant resin composition on the tan δ curve determined by the dynamic viscoelasticity measurement defined in Japanese Industrial Standard K 7244-4 appears at a temperature lower than a temperature at which a p relaxation peak of a composition composed singly of a polybutylene terephthalate appears; and said another component is dispersed in said polybutylene terephthalate resin phase in a form of particles having sizes of 1 μm or smaller.

According to a second aspect of the present invention, said another component is comprised of a polyolefin, and the tensile elongation of the heat-resistant resin composition described in the first aspect of which comprising the component described above is 200% or larger after being exposed to a temperature of 150° C.

According to a third aspect of the present invention, said another component is comprised of a polyolefin and an elastomer of which glass transition temperature is −30° C. or lower; and the tensile elongation of the heat-resistant resin composition described in the first aspect of which comprising the component described above is 200% or larger after being exposed to a temperature of 150° C.

According to a fourth aspect of the present invention, said another component is comprised of; a polyolefin, elastomer of which glass transition temperature is −30° C. or lower and a compatibility accelerator, and the tensile elongation of the heat-resistant resin composition described in the first aspect of which comprising the component described above is 200% or larger after being exposed to a temperature of 150° C.

According to a fifth aspect of the present invention, said polyolefin comprised in the heat-resistant resin composition described in any one of second aspect to fourth aspect is at least one of a high-density polyethylene and a low-density polyethylene.

According to a sixth aspect of the present invention, said elastomer, of which glass transition temperature is −30° C. or lower comprised in the heat-resistant resin composition described in any one of third aspect to fifth aspect, is a hydrogenated block copolymer comprised of styrene-butadiene-styrene (SEBS).

According to a seventh aspect of the present invention, said compatibility accelerator comprised in the heat-resistant resin composition described in any one of fourth aspect and fifth aspect, is comprised of at least one substance selected from the group consisting of triglycidyl cyanurate, monoallyl diglycidyl cyanurate, a copolymer of ethylene-glycidyl methacrylate-vinyl acetate, and a copolymer of ethylene-glycidyl methacrylate-methyl acrylate.

According to an eighth aspect of the present invention, an insulated wire is having an insulation layer comprised of the heat-resistant resin composition described in any one of first aspect to seventh aspect, wherein the wall thickness of said insulation layer of said heat-resistant resin composition is 0.1 mm to 0.5 mm.

The present invention provides a heat-resistant resin composition that is a kneaded mixture of polybutylene terephthalate (PBT) and a component different from PBT. A kneading applied to such mixture shifts the p relaxation peak temperature of the resin composition on the tan δ curve determined by a dynamic viscoelasticity measurement to a temperature lower than the β relaxation peak temperature of PBT, with a performance of a tensile elongation being 200% or larger even after being exposed to a temperature of 150° C. This heat-resistance resin composition is therefore usefully applicable to vehicular insulated wires such as automobiles or railway cars.

### BRIEF DESCRIPTION OF DRAWINGS

FIG. 1

An explanatory illustration to explain a β relaxation peak on the tan δ curve determined by a dynamic viscoelasticity measurement conducted on PBT resin.

### DESCRIPTION OF EMBODIMENTS

The following details a preferred embodiment of the present invention.

The heat-resistant resin composition used in embodiments of the present invention is a kneaded mixture of polybutylene terephthalate (PBT) and a component different from PBT. A kneading applied to such mixture shifts the β relaxation peak temperature of the resin composition on the tan δ (loss tangent) curve determined by the dynamic viscoelasticity measurement defined in Japanese Industrial Standard (JIS) K 7244-4 to a temperature lower than the βrelaxation peak temperature of PBT.

The β relaxation peak discussed here is a relaxation peak that is originated in a molecular motion of a side chain linked with the principal chain in PBT or in a local movement of molecules in the principal chain skeleton.

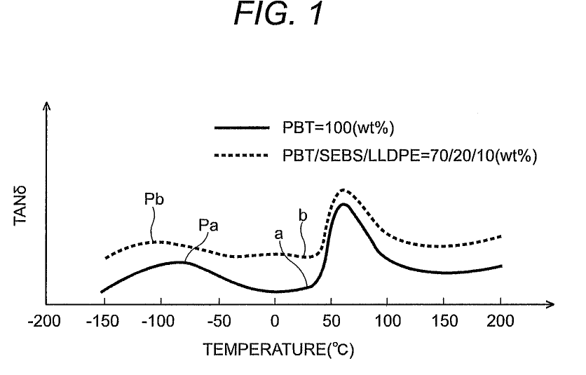

In the case of PBT, the β relaxation peak Pa on the tan δ curve a shown in a solid line in FIG. 1 is observed appearing in a temperature range of −90° C. to −60° C.

In the present invention, it is considered that making the P relaxation peak appear at a low temperature enables molecular movements to be active from lower temperatures giving a good elongation in a tensile test.

Kneading PBT resin mixing with a substance like a high-density or a low-density polyolefin, or an elastomer of which glass transition temperature of −30° C. or lower, can shift the β relaxation peak on the tan δ curve to a lower temperature. In this kneading however such mixed-in component different from PBT should be dispersed in the PBT resin phase in a form of particles having sizes of 1 μm or smaller.

The tan δ curve b shown in a dashed line in FIG. 1 represents behavior of comparative example 3, which will be discussed later. Where the sizes of dispersed particles are larger than 1 μm (3 μm as in the example), the elongation degrades even though the relaxation peak Pb determined by the viscoelasticity measurement has shifted to a lower temperature.

In the present invention, shift of the p relaxation peak temperature on the tan δ curve to a lower temperature by kneading a polyester resin including PBT resin together with a polyolefin alone, or together with a polyolefin and an elastomer of which glass transition temperature is −30° C. or lower, and the kneading disperses the component different from PBT in the PBT resin phase in a form of particles having sizes of 1 μm or smaller makes a tensile elongation of a heat-resistant resin composition by 200% or larger after being exposed to a temperature of 150° C.

In case the tensile elongation is below 200%, a wire insulated with such resin composition loses flexibility and is not usable for insulated wires for vehicular use.

The polyester resin including PBT resin in the present invention is preferred to be polyethylene terephthalate, polybutylene terephthalate (PBT), or polybutylene isophthalate. Particularly, such a PBT resin as has a conventionally known structure is acceptable and there is no limitation to the molecular configuration thereof.

As the polyolefin resin, it is preferred to use at least one of a high-density polyethylene resin and a low-density polyethylene (such as a linear chain low density polyethylene (LLDPE)).

As for the elastomer having the glass transition temperature of −30° C. or lower, there is no particular restriction. For a better result however, it is preferred to use a block copolymer of styrene and diene (butadiene and isoprene for example) like a block copolymer of styrene-butadiene (SBS and SBR for example), or a hydrogenated block copolymer (SEBS for example) saturated by hydrogenating double bonds in a block copolymer of styrene-isoprene (SIS for example). Block copolymers like these are acceptable even when they are denatured with organic carboxylic acid if necessary.

To enhance the dispersibility of a polyolefin resin and an elastomer having a glass transition temperature of −30° C. or lower, and to improve the elongation property of a heat-resistant resin composition, it may be practicable to add thereto a compound (a compatibility accelerator) that has a glycidyl group such as a copolymer of ethylene-glycidyl methacrylate copolymer (EGMA).

Above-stated compatibility accelerator can be used in a single substance, or in a combination of two or more substances, selected from the group consisting of triglycidyl cyanurate, mono allyl diglycidyl cyanurate, copolymer of ethylene-glycidyl methacrylate-vinyl acetate, copolymer of ethylene-glycidyl methacrylate-methyl acrylate.

The heat-resistant composition by the present invention is preferably to be used in an insulation material for vehicular wires. In such use, a preferred insulation thickness is 0.1 mm to 0.5 mm, or 0.1 mm to 0.3 mm for more preferable application.

If the insulation thickness is more than such values, requirements for wires having lighter weight and thinner thickness would not be satisfied; and accordingly the weight reduction of car bodies and the space saving in wiring practice, which are demands in the transportation field such as automobiles or railway cars, will not be fulfilled. If the insulation thickness is below such values, the abrasion resistivity of the wire lowers, which means that the properties of wires are intolerably poor as the vehicular wires.

The heat-resistant resin composition by the present invention may be used with an addition of a nitrogen-containing compound to enhance flame retardancy. The nitrogen-containing compound as a flame retardant includes, for example, melamine cyanurate, melamine, cyanuric acid, isocyanuric acid, a triazine derivative, and an isocyanurate derivative. Among these, melamine cyanurate is the most preferable substance for the purpose. Melamine cyanurate is used in a form of particles. This substance may be used in un-treated state, or it may be used in a surface-treated state treated with a surface preparation agent (such as aminosilane coupling agent, epoxysilane coupling agent, and vinylsilane coupling agent), or higher fatty acid (stearic acid and oleic acid for example). Adding ratio of these nitrogen-containing compounds is usually 5 to 40 parts by weight, preferably 5 to 30 parts by weight, to 100 parts by weight of the heat-resistant resin composition. If the content of the nitrogen-containing compound is in excess of this value, the abrasion resistivity of the heat-resistance resin compound decreases. If the content of the nitrogen-containing compound is below this value, sufficient flame retardancy could not be obtained.

Another resins or additives could be added to the heat-resistant resin composition in order to improve moldability or to improve property of a molded article, within such an amount as does not depart from the purpose of the present invention.

Additives for this purpose typically include: antioxidizing agent, reinforcement, filler, thermal stabilizer, ultraviolet absorbing agent, lubricant, pigment, dye, flame retardant, plasticizer, crystal nucleating agent, and anti-hydrolytic agent.

Above-stated composition can be manufactured by melt kneading using a batch kneader or a twin-screw extruder. Extruders for this purpose however are not limited to a twin-screw type. The kneaded-mixture prepared through such melt kneading is pelletized to a rice-grain size followed by pre-drying in a vacuum dryer.

A conductor for the insulated wire by the present invention may be: a solid copper wire, a stranded copper wire, or a braided copper wire. The copper wire therein may be a hot-dipping tinned or electrolytic tinned copper wire. A preferable diameter of the conductor is 0.5 mm to 2 mm or similar. The cross-sectional shape of the conductor is not limited to a round shape. Use of such a flat wire as is manufactured by slitting copper strip or by rolling a round-shaped wire for example is also usable.

The insulated wire by the present invention is an electrical wire having a conductor covering layer of the heat-resistant resin composition manufactured by a melt kneading method, as stated above.

The insulated wire by the present invention can be manufactured by a known method. That is, extruding the heat-resistant resin composition on or over a conductor or a plurality of conductors using an ordinary extruder can manufacture the invented insulated wire.

### Embodiments

The following details embodiments of the present invention and comparative examples. The form of implementing the present invention however is not limited to such embodiments.

Properties of embodiments 1 to 4 and comparative examples 1 to 4 are listed in Table 1.

TABLE 1

| | | | | | β relaxation | | | |
|---|---|---|---|---|---|---|---|---|
| | | | | | Peak | | Tensile | |
| | | | | | Temperature | Dispersed | Elongation | |
| | | | | | Determined by | Particle Size | after | |
| | | | | | Dynamic | Examined with | Exposure to | |
| | Resin Composition | | | | Viscoelasticity | TEM | High | |
| | (wt %) | | | | Measurement | Observation | Temperature | |
| Specimen | PBT | SEBS | LLDPE | EGMA | (° C.) | (μm) | (%) | Evaluation |
| Embodiment 1 | 70 | 20 | 5 | 5 | −107 | 0.4 | 410 | ◯ |
| Embodiment 2 | 70 | 20 | Nil | 10 | −110 | 0.5 | 310 | ◯ |
| Embodiment 3 | 70 | Nil | 25 | 5 | −110 | 0.5 | 350 | ◯ |
| Embodiment 4 | 90 | Nil | 10 | Nil | −112 | 0.7 | 220 | ◯ |
| Comparative | 100 | Nil | Nil | Nil | −79 | N.A. | 0 | N.A. |
| Example 1*¹ | | | | | | | | |
| Comparative | 80 | 20 | Nil | Nil | −108 | 3 | 30 | X |
| Example 2 | | | | | | | | |
| Comparative | 70 | 20 | 10 | Nil | −109 | 4 | 20 | X |
| Example 3 | | | | | | | | |
| Comparative | 90 | Nil | Nil | 10 | −80 | N.A. | 0 | X |
| Example 4*² | | | | | | | | |

Remarks:
wt % weight-percent
Nil None
TEM Transmission electron microscope
N.A. Not applicable
◯ Acceptable
X Not acceptable
*¹No dispersed particles observed since the composition of this embodiment contains PBT only.
*²No dispersed particles observed since the composition of this example has no sea-island structure.

### (Manufacturing Insulated Wires)

Pellets of a resin composition were prepared by kneading a mixture of components provided in the weights according to Table 1 at 260° C. using a twin-screw extruder. The resin composition thus prepared was dried at 120° C. for 10 hours in vacuum. Then, the resin composition was extruded on a tinned annealed copper wire having a diameter of 1.3 mm with a wall thickness of 0.3 mm. The extrusion used a die having a diameter of 4.2 mm and a nipple having a diameter of 2.0 mm. Extrusion temperatures were 230° C. to 260° C. at the cylinder and 260° C. at the cross-head. Extrusion line speed was 5 m/min.

### (Dynamic Viscoelasticity Measurement (As per JIS K 7244-4))

A tube-shaped test piece of the insulation layer was prepared by removing the conductor by pulling out from a length of the insulated wire. The test piece was exposed to a high-temperature in a manner defined below. Then the test piece was tested for its dynamic viscoelasticity property rising ambient temperature at a rate of 5° C./min and vibrating at the frequency of 10 Hz.

(Tensile Test after High-Temperature Exposure)

A die-stamped dumbbell 5A style test piece (74 mm in entire length and 4 mm in width of parallel section) was prepared from a sheet specimen of the invented resin composition having a thickness of 1 mm. The test piece was heated at 150° C. for 100 hours in a thermostatic oven. It was then taken out from the oven and left at a room temperature for about 12 hours before the tensile test. This heating-cooling condition was determined according to JIS C 3005 WL1.

The tensile test was conducted on the above-stated dumbbell test piece at a pulling speed of 200 mm/min. Further details of the tensile test conditions followed requirements defined in JIS C 3005. Evaluation of the test results were indicated with marks: ◯ (acceptable) where the tensile elongation was 200% or more and X (not acceptable) for the tensile elongation after exposure to high-temperature was below 200%.

### (Observation Under TEM)

The heat-resistant resin composition covering the wire was frozen up at −120° C. The frozen composition was then cut into a slice having a thickness of 70 nm using an ultramicrotome. The slice, the test piece, was stain-processed with ruthenium tetroxide for 20 hours to put the stained slice under the observation by a transmission electron microscope (TEM).

Table 1 shows the following aspects. Comparative example 1 was a resin composition that contains PBT in 100 wt %. The β relaxation peak of this example on the tan δ curve of a dynamic viscoelastic coefficient appeared at the temperature of −79° C.; a morphological observation with TEM found no dispersed particles; and the tensile elongation after exposure to high-temperature was 0%. Comparative example 2, which was prepared by kneading PBT (80 wt %) with 20 wt % of SEBS, and comparative example 3, which was prepared by kneading PBT (70 wt %) with 20 wt % of SEBS and 10 wt % of LLDPE, these two examples showed shifts in the β relaxation peak temperatures to lower temperatures, namely to −108° C. and −109° C. respectively. The morphological observation with TEM however revealed that the sizes of particles dispersed in PBT phase in these examples were as large as 3 μm and 4 μm respectively. Further, their tensile elongations after exposure to high-temperature were as poor as 30% and 20% respectively.

In contrast, the resin compositions in embodiments 1 to 4 showed that their β relaxation peak temperatures on the tan δ curves determined by the dynamic viscoelasticity measurement were shifted to lower temperatures and that the sizes of particles dispersed in their PBT phases were 1 μm or smaller according to a morphological observation with TEM; thereby their tensile elongations after exposure to high-temperature were as good as 200% or more.

Comparative example 4 was prepared by kneading PBT (90 wt %) with 10 wt % of EGMA. This example showed very poor elongation properties because of little lowering in the p relaxation peak temperature determined by the viscoelasticity measurement compared with comparative example 1 and non-existence of dispersed particles therein.

It is found from Results shown in Table 1 that kneading 20 wt % of SEBS with PBT shifts the β relaxation peak temperature to a lower temperature at the expense of larger sizes of dispersed particles (comparative example 2), and that kneading 10 wt % of LLDPE additionally to the above formula enlarges the sizes of dispersed particles (comparative example 3). Thus, it is a preferable formula to knead therein LLDPE and EGMA each by 5 wt % like embodiment 1, or to knead therein EGMA by 10 wt % like in embodiment 2 without adding LLDPE. In case SEBS is not kneaded, it is a preferable formula to knead therein LLDPE alone by 10 wt % (embodiment 4) or if LLDPE is kneaded by 25 wt %, it is a preferable formula to knead therein EGMA by 5 wt %. In comparative examples 2 and 3, wherein EGMA was not added thereto, the sizes of the dispersed particles were larger than those sizes in embodiments 1 to 4. This means that EGMA effectively serves as a compatibility accelerator.

1. A heat-resistant resin composition comprised of a mixture prepared by kneading a polybutylene terephthalate resin together with a component different from said polybutylene terephthalate resin, wherein a β relaxation peak of said heat-resistant resin composition on the tan δ curve determined by the dynamic viscoelasticity measurement defined in Japanese Industrial Standard K 7244-4 appears at a temperature lower than a temperature at which a β relaxation peak of a composition composed singly of a polybutylene terephthalate appears; and said another component is dispersed in said polybutylene terephthalate resin phase in a form of particles having sizes of 1 μm or smaller.

2. The heat-resistant resin composition according to claim 1, wherein said another component is comprised of a polyolefin and the tensile elongation of said heat-resistant resin composition is 200% or larger after being exposed to a temperature of 150° C.

3. The heat-resistant resin composition according to claim 1, wherein said another component is comprised of a polyolefin and an elastomer of which glass transition temperature is −30° C. or lower; and the tensile elongation of said heat-resistant resin composition is 200% or larger after being exposed to a temperature of 150° C.

4. The heat-resistant resin composition according to claim 1, wherein said another component is comprised of a polyolefin, an elastomer of which glass transition temperature is −30° C. or lower, and a compatibility accelerator; and the tensile elongation of said heat-resistant resin composition is 200% or larger after being exposed to a temperature of 150° C.

5. The heat-resistant resin composition according to claim 2, wherein said polyolefin is at least one of a high-density polyethylene and a low-density polyethylene.

6. The heat-resistant resin composition according to claim 3, wherein said elastomer, of which glass transition temperature is −30° C. or lower, is a hydrogenated block copolymer comprised of styrene-butadiene-styrene (SEBS).

7. The heat-resistant resin composition according to claim 5, wherein said elastomer, of which glass transition temperature is −30° C. or lower, is a hydrogenated block copolymer comprised of styrene-butadiene-styrene (SEBS).

8. The heat-resistant resin composition according to claim 4, wherein said compatibility accelerator is comprised of at least one substance selected from the group consisting of triglycidyl cyanurate, monoallyl diglycidyl cyanurate, a copolymer of ethylene-glycidyl methacrylate-vinyl acetate, and a copolymer of ethylene-glycidyl methacrylate-methyl acrylate.

9. The heat-resistant resin composition according to claim 5, wherein said compatibility accelerator is comprised of at least one substance selected from the group consisting of triglycidyl cyanurate, monoallyl diglycidyl cyanurate, a copolymer of ethylene-glycidyl methacrylate-vinyl acetate, and a copolymer of ethylene-glycidyl methacrylate-methyl acrylate.

10. An insulated wire having an insulation layer comprised of the heat-resistant resin composition according to claim 1, wherein the wall thickness of said insulation layer of said heat-resistant resin composition is 0.1 mm to 0.5 mm.

11. An insulated wire having an insulation layer comprised of the heat-resistant resin composition according to claim 5, wherein the wall thickness of said insulation layer of said heat-resistant resin composition is 0.1 mm to 0.5 mm.

12. An insulated wire having an insulation layer comprised of the heat-resistant resin composition according to claim 6, wherein the wall thickness of said insulation layer of said heat-resistant resin composition is 0.1 mm to 0.5 mm.

13. An insulated wire having an insulation layer comprised of the heat-resistant resin composition according to claim 7, wherein the wall thickness of said insulation layer of said heat-resistant resin composition is 0.1 mm to 0.5 mm.
